(19) United States
(12) Patent Application Publication
(10) Pub. No.: US 2006/0208409 A1
(43) Pub. Date: Sep. 21, 2006

(54) Workbench for preparing a workpiece to be machined on a digitally controlled machine

(76) Inventors: Jacques Thibaut, Vaudry (FR); Christophe Thibaut, Vire (FR)

Correspondence Address: Cohen, Gary M, Strafford Building Number Three, 125 Strafford Avenue, Suite 300, Wayne, PA, 19087-3318, US

(21) Appl. No.: 10/550,780

(22) PCT Filed: Mar. 4, 2004
(86) PCT No.: PCT/FR04/00507

§ 371 Date: Sep. 27, 2005

(30) Foreign Application Priority Data
Mar. 31, 2003 (FR) 03/03918

(51) Int. Cl. B23Q 1/25

(52) U.S. Cl. 269/73

(57) ABSTRACT

The present invention relates to a workbench for preparing a workpiece intended to be machined on a machine tool, particularly numerically controlled, characterized in that it consists of:

a platform (8) made of granite placed horizontally on a frame (9),

two guide rods (10, 11) perpendicular to one another, one of which (11) being movable relative to the other (10), arranged in a parallel plane at a distance from the plane formed by the platform (8), each of the rods (10, 11) also being provided with a linear measurement system (13), and

a means (12) of viewing the coordinates of a point on the platform (8), said means being capable of being moved by an operator on said movable rod (11).

The present invention relates to a workbench for preparing a workpiece intended to be machined on a numerically controlled machine.

It relates more particularly to a workbench for positioning means of clamping said workpiece onto the machine tool.

On numerically controlled machines intended mainly for machining, for example, kitchen or bathroom worktops, means of clamping a workpiece are known that usually consist of single or double-faced suction cups, provided with supply pipes for reducing their pressure, positioned between the bottom of the workpiece to be machined and the top of the table of the machine tool, thus allowing the machine to move on the four sides and the top face of the workpiece to be machined and to do so without removal between the operations.

Also currently known are two principles of positioning the means of clamping the workpiece. The first principle consists in the installation, manually by the operator, of the suction cups furnished with their supply pipes while following the positioning instructions specified by the numerically controlled machine, fitted for this purpose with a laser attached in a spindle, or any other means such as a pin gage or water jet, that is connected to a software program that can be used, depending on the machining operations to be performed, to determine the position of each suction cup. A second principle consists in having the suction cups installed directly by the numerically controlled machine fitted with an automatic gripping means, for example a pincer, mounted on the spindle of said machine.

In order to ensure good quality of work, the workpiece needs to be perfectly immobilized and not move during the various machining operations, consequently requiring the installation of a very large number of clamping suction cups.

In addition, these clamping means must be positioned with precision so as not to be damaged during the through-hole machining operations (for example: drillholes).

It is understood that during the installation of this plurality of suction cups according to one or other of the principles described hereinabove, the machine tool is not productive. However, this machine tool downtime is counted in the total production time of the workpiece, consequently causing an increase in the final cost price of the workpiece to be machined.

The object of the invention is to provide a workbench for preparing a workpiece to be machined on a machine tool that remedies some or all of the aforementioned disadvantages.

Accordingly, the subject of the present invention is a workbench for preparing a workpiece intended to be machined on a machine tool, particularly numerically controlled, characterized in that it consists of:
an upper platform (rigid and solid) placed horizontally on a frame (for example, a table made of granite),
two guide rods perpendicular to one another, one of which is movable relative to the other, arranged in a parallel plane at a distance from the plane formed by the upper platform, each of the rods also being provided with a linear measurement system, and
a means of viewing the coordinates of a point on the platform, capable of being moved by an operator on said movable rod.

According to some worthwhile provisions of the invention:
the workbench comprises at least one vacuum rail disposed on the frame,
the means of viewing the coordinates of a point consists of a laser, for example battery-powered, mounted on a carriage capable of being moved by means of a handle on the movable rod,
the frame comprises a lower platform, and rollers.

The features of the aforementioned invention, and others, will emerge more clearly on reading the following description of an exemplary embodiment, with reference to the appended drawings in which:

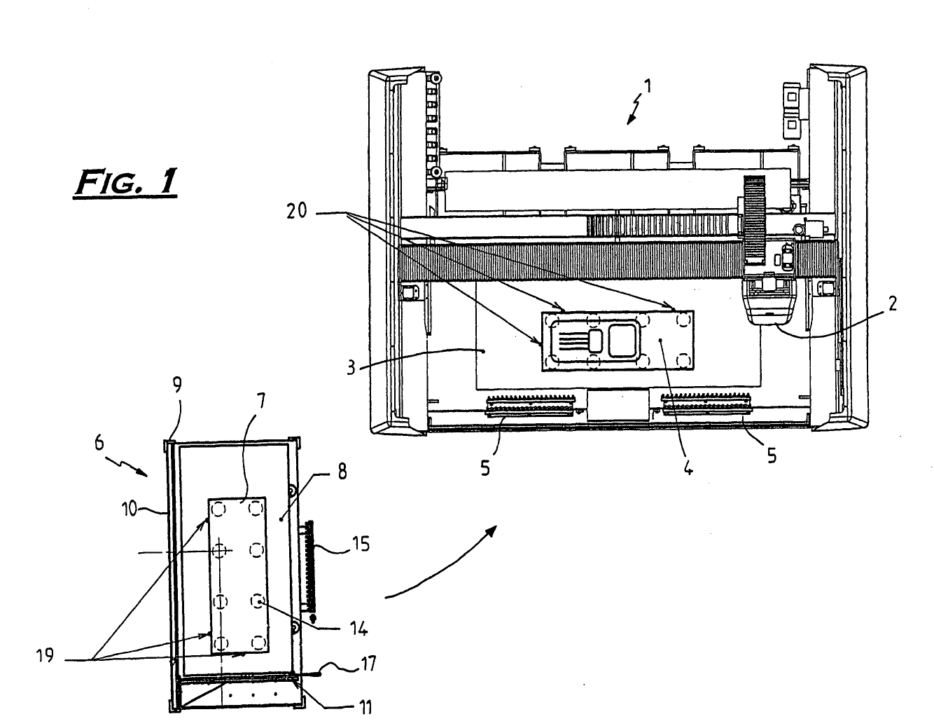

FIG. 1 is a top view of a machine tool fitted with a preparation workbench according to the present invention, and

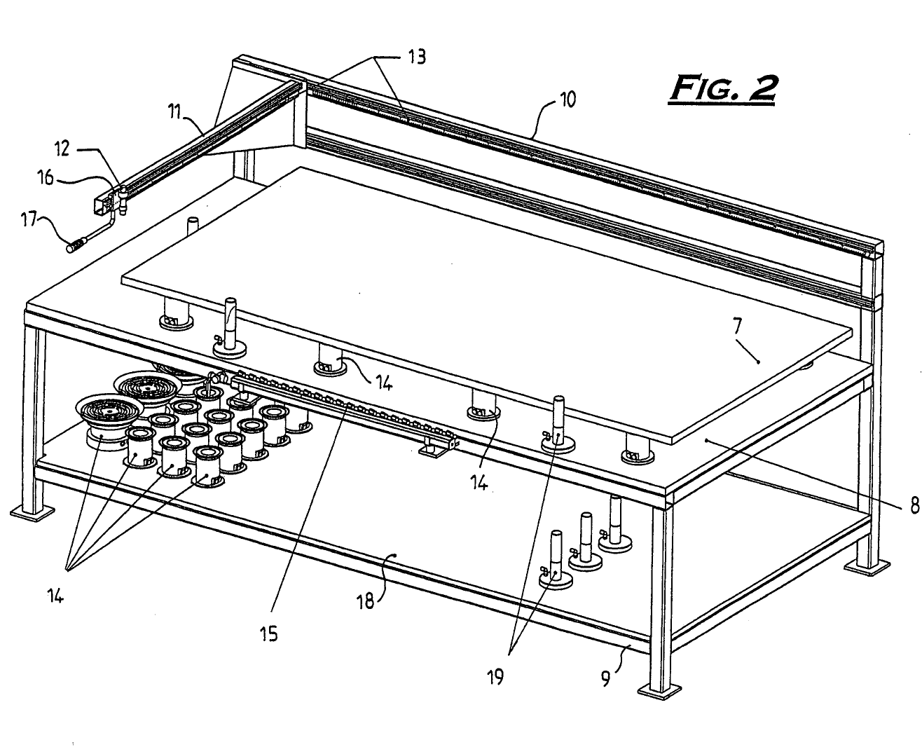

FIG. 2 is a view in perspective of the preparation workbench.

FIG. 1 shows a numerically controlled machine tool 1 provided in conventional manner with a movable spindle 2, a machining table 3 intended to receive a workpiece 4 and vacuum rails 5 for immobilizing the means 14 of clamping said workpiece 4 onto the table 3.

Close to said machine tool 1, according to the present invention, a preparation workbench 6 is arranged whereby the operator can prepare the next workpiece while the machine tool 1 is working.

To do this, this workbench 6 for preparing a workpiece 7 to be machined consists of a platform 8 that can be made of granite or other material, placed horizontally on the frame 9, two guide rods 10 and 11 perpendicular to one another, one of which 11 is movable relative to the other 10, arranged in a parallel plane at a distance from the plane formed by the platform 8, and a means 12 of viewing the coordinates of a point on the platform 8 capable of being moved by an operator on said movable rod 11.

Each of the rods 10 and 11 is also provided with a linear measurement system 13 thus making it possible to adjust the center of each clamping suction cup 14 to be positioned on the platform 8 of the workbench.

It should be noted that each coordinate of each of the suction cups 14 comes directly from a computer-aided manufacturing program depending on the shape of the workpiece and the machining operations to be performed.

The frame 9 of the preparation workbench is also provided with at least one vacuum rail 15 in order, by means of supply pipes, to reduce the pressure of each suction cup 14 thus ensuring that the suction cups connect onto the workpiece, as explained in greater detail in the rest of the description.

According to a preferred embodiment, note that the means 12 of viewing the coordinates of a point advantageously consists of a laser, for example battery-powered, mounted on a carriage 16 capable of being moved by means of a handle 17 on the movable rod 11.

This movable rod 11 is arranged on a carriage mounted on the fixed rod 10 thus also allowing it to be moved longitudinally on the fixed rod by means of said handle 17.

Note that the frame 9 may comprise a lower platform 18 for the storage of various suction cups 14 or tools needed for the preparation of a workpiece.

The operation of the workbench 6 for preparing a workpiece is already emerging from the description made thereof hereinabove and will now be explained with reference to the figures.

The operator has stops 19 for positioning the workpiece and suction cups 14 on the platform 8 of the preparation workbench in the location determined by the software program. For this, he reads the coordinates of each center of the suction cups 14 to be positioned and moves the movable rod 11 on the fixed rod 10 and the laser 12, in order to view this point on the platform 8 and to position the suction cup 14. To prevent any risk of moving the prepositioned suction cups, the operator may reduce the pressure between the bottom face of the suction cups and the top of the platform.

When all the suction cups 14 are positioned, the operator places the workpiece 7 in contact on the three reference stops 19 and on the top face of the suction cups 14, then reduces pressure on the top face of the suction cups 14 by means of the vacuum rail 15 in order to attach the workpiece to the suction cups 14. If the operator has secured the position of the suction cups on the upper platform, he must then release the vacuum between the bottom face of the suction cup and the upper platform.

When the machine has finished a machining cycle, the operator removes the machined workpiece with the aid of a handling means, for example a vacuum lifting beam (not shown), then uses the same handling means to pick up the next workpiece fitted with suction cups, in order to place it on the table 3 of the machine tool 1 in contact with the positioning stops 20 attached to the machine.

The operator then reduces pressure on the lower face of the suction cups 14 by connecting each supply pipe, not shown, to a vacuum rail 5 in order to attach the workpiece to the table 3 of the machine.

A new machining cycle may then be started while the operator prepares a new workpiece.

It is understood on reading the above description that the preparation workbench 6 according to the present invention can be used to limit the downtime of the machine to the time for unloading the machined workpiece and loading the workpiece, all the operations relating to the positioning of the clamping device being performed in concurrent operating time.

In addition, this preparation method is more user-friendly and less dangerous for the operator who is not obliged to climb onto the table to position each suction cup (if ten suction cups are necessary, he climbs on the table ten times).

Thus, such a workbench, relatively simple to produce, can be used to produce more, thus reducing the time spent on each workpiece and consequently its cost.

Although the invention has been described with reference to a particular embodiment, it comprises all the technical equivalents of the means described.

Thus, according to a variant embodiment, the preparation workbench may be fitted with a frame on rollers so that it can be easily moved.

In addition, without departing from the scope of the invention:
1/ the clamping means may be different,
2/ the movement of the laser may be motorized so that the center of the suction cups can be positioned automatically.

1. A workbench for preparing a workpiece intended to be machined on a machine tool, particularly numerically controlled, characterized in that it consists of:
a platform (8) made of granite placed horizontally on a frame (9),
two guide rods (10, 11) perpendicular to one another, one of which (11) is movable relative to the other (10), arranged in a parallel plane at a distance from the plane formed by the platform (8), each of the rods (10, 11) also being provided with a linear measurement system (13), and
a means (12) of viewing the coordinates of a point on the platform (8), said means being capable of being moved by an operator on said movable rod (11).

2. The preparation workbench as claimed in claim 1, characterized in that the means (12) of viewing the coordinates of a point consists of a battery-powered laser (12) mounted on a carriage (16) capable of being moved by means of a handle (17) on the movable rod (11).

3. The preparation workbench as claimed in either one of the preceding claims, characterized in that it comprises at least one vacuum rail (15) disposed on the frame (8).
